(19) United States
(12) Patent Application Publication
(10) Pub. No.: US 2022/0289568 A1
(43) Pub. Date: Sep. 15, 2022

(54) APPARATUS AND METHOD FOR PRODUCING HYDROGEN SULFIDE (H2S) FOR LABORATORY USE

(71) Applicant: ABU DHABI OIL REFINING COMPANY - TAKREER, Abu Dhabi (AE)

(72) Inventors: Mabruk Issa SULEIMAN, Abu Dhabi (AE); Mohammad Abdur RAKIB, Abu Dhabi (AE); Nilesh CHANDAK, Abu Dhabi (AE)

(21) Appl. No.: 17/629,874

(22) PCT Filed: Aug. 2, 2019
(86) PCT No.: PCT/IB2019/056604

§ 371 Date: Jan. 25, 2022

(51) Int. Cl. C01B 17/16

(52) U.S. Cl. CPC C01B 17/16

(57) ABSTRACT

An apparatus for in situ producing hydrogen sulfide (H₂S) for laboratory use comprises a feed preparation section (A) for pre-treating a liquid feedstock with organic sulfur containing components; a hydrogen sulfide (H₂S) production section (B) downstream of the feed preparation section (A) for producing hydrogen sulfide (H₂S) from the organic sulfur containing components at elevated temperature; a separation section (C) downstream of the hydrogen sulfide (H₂S) production section (B) for separating a vaporous portion of the liquid feedstock from a liquid portion at a temperature lower than the elevated temperature of section (B); a product analysis section (D) downstream of the separation section for analysing the amount of hydrogen sulfide (H₂S) in the vaporous portion; a plurality of feeding lines for conveying the liquid feedstock; and a direct feeding line (E) from the separation section (C) for directly introducing the vaporous portion of the liquid feedstock into the laboratory setup.

The present invention relates to an apparatus and process suitable for in situ production of hydrogen sulfide (H₂S) for laboratory use.

### BACKGROUND ART

Hydrogen sulfide (H₂S) can be used in analytical chemistry for the quantitative inorganic analysis of metal ions or as precursor to elemental sulfur, thioorganic compounds and metal sulfides.

Further, hydrogen sulfide is used as a corrosion marker for simulating corrosion in chemical processes especially in the refining and petrochemical industry.

Hydrogen sulfide is an extremely toxic gas, and hence for laboratory applications, extreme precautions need to be taken for storage of gas cylinders, the piping system, and ventilation. Due to the high levels of risks involved, many research activities requiring H₂S supply are usually avoided.

Since storage of H₂S inside laboratory premises should be avoided one possibility to obtain H₂S for laboratory use is on-site production of H₂S for continuous consumption as required by the facility. There are several processes commercially available for production of hydrogen sulfide. The major commercial processes include recovering H₂S from sour natural gas and reaction of elemental sulfur with hydrogen. However, these processes are not practical for small laboratories.

Standard laboratory in situ preparation is to treat ferrous sulfide with a strong acid in a Kipp generator. However, the resultant product is contaminated with gases such as carbon dioxide and oxygen originating from the educts of said reaction. Such gases could be detrimental to desired test results and the integrity of the laboratory equipment due to enhanced corrosivity. Thus, there is a need in the art for a reliable and safe setup and process for in situ producing hydrogen sulfide (H₂S) for laboratory use.

### SUMMARY OF THE INVENTION

The present invention relates to an apparatus for in situ producing hydrogen sulfide (H₂S) for laboratory use comprising

a feed preparation section (A) for pre-treating the liquid feedstock which comprises organic sulfur containing components;

a hydrogen sulfide (H₂S) production section (B) downstream the feed preparation section (A) for producing hydrogen sulfide (H₂S) from the organic sulfur containing components in the liquid feedstock at elevated temperature;

a separation section (C) downstream the hydrogen sulfide (H₂S) production section (B) for separating a vaporous portion of the liquid feedstock containing hydrogen sulfide (H₂S) from a liquid portion of the liquid feedstock at a temperature lower than the elevated temperature of the hydrogen sulfide (H₂S) production section (B);

a product analysis section (D) downstream the separation section for analyzing the amount of hydrogen sulfide (H₂S) in the vaporous portion of the liquid feedstock;

a plurality of feeding lines for conveying the liquid feedstock from the feed preparation section (A) to the hydrogen sulfide (H₂S) production section (B) to the separation section (C) and to the product analysis section (D); and

a direct feeding line (E) from the separation section (C) to a laboratory setup for directly introducing the vaporous portion of the liquid feedstock containing hydrogen sulfide (H₂S) into the laboratory setup.

Further, the present invention relates to a process for in-situ producing hydrogen sulfide (H₂S) for laboratory use comprising the following steps:
a) providing a liquid feedstock, which comprises organic sulfur containing components;
b) pre-treating the liquid feedstock;
c) producing hydrogen sulfide (H₂S) from the organic sulfur containing components in the pre-treated liquid feedstock at an elevated temperature;
d) separating a vaporous portion of the liquid feedstock containing the hydrogen sulfide (H₂S) from a liquid portion of the liquid feedstock at a temperature lower than the elevated temperature of hydrogen sulfide (H₂S) production step c);
e) analyzing the amount of hydrogen sulfide (H₂S) in the vaporous portion of the liquid feedstock; and
f) directly feeding the vaporous portion of the liquid feedstock containing the hydrogen sulfide (H₂S) into a laboratory setup.

Still further, the present invention relates to the use the apparatus as defined above or below and/or the process as defined above or below for in-situ producing hydrogen sulfide (H₂S) for laboratory use.

Additionally, the present invention relates to the use of the apparatus as defined above or below and/or the process as defined above or below for creating data banks of the production of hydrogen sulfide (H₂S) from various specific liquid feedstock species under different production conditions.

The apparatus and process according to the invention are especially suitable for in situ producing hydrogen sulfide (H₂S) from liquid feedstock under precisely controlled operating conditions of temperature, pressure, and feed rates, as per requirement of the target concentration requirement in the laboratory experiment.

The apparatus and process according to the invention can further be used for creating data banks of the production of hydrogen sulfide (H₂S) from various specific liquid feedstock species such as e.g. different fractions of distilled crude oil or condensates of different exploitation sites, under different production conditions.

The advantages of the apparatus and process of the present invention are:
Storage of toxic hydrogen sulfide in laboratories can be avoided. Instead hydrogen sulfide is created in situ when needed in the required amounts and flow rates.
The availability of hydrogen sulfide can easily be controlled. The apparatus is started upon need and shut off immediately when hydrogen sulfide is no longer required.
The required concentration of hydrogen sulfide can be easily controlled by using data banks created by calibrating the production conditions of the apparatus for different specific liquid feedstock species.

### FIGURE

FIG. 1 shows a diagrammic view of an apparatus for in situ producing hydrogen sulfide (H₂S) for laboratory use according to the invention.

### DETAILED DESCRIPTION

Apparatus

The present invention relates to an apparatus for in situ producing hydrogen sulfide (H₂S) for laboratory use comprising

a feed preparation section (A) for pre-treating the liquid feedstock which comprises organic sulfur containing components;

a hydrogen sulfide (H₂S) production section (B) downstream the feed preparation section (A) for producing hydrogen sulfide (H₂S) from the organic sulfur containing components in the liquid feedstock at elevated temperature;

a separation section (C) downstream the hydrogen sulfide (H₂S) production section (B) for separating a vaporous portion of the liquid feedstock containing hydrogen sulfide (H₂S) from a liquid portion of the liquid feedstock at a temperature lower than the elevated temperature of the hydrogen sulfide (H₂S) production section (B);

a product analysis section (D) downstream the separation section for analysing the amount of hydrogen sulfide (H₂S) in the vaporous portion of the liquid feedstock;

a plurality of feeding lines for conveying the liquid feedstock from the feed preparation section (A) to the hydrogen sulfide (H₂S) production section (B) to the separation section (C) and to the product analysis section (D); and

a direct feeding line (E) from the separation section (C) to a laboratory setup for directly introducing the vaporous portion of the liquid feedstock containing hydrogen sulfide (H₂S) into the laboratory setup.

The feed preparation section preferably comprises a vessel (A-1) for storing liquid feedstock, a vessel (A-2) for storing further components, means (A-3) for mixing and preheating the liquid feedstock and the further components and means (A-4) for controlling flow rate of the further components.

The vessel (A-1) for storing liquid feedstock can comprise means for calibrating the amount of liquid feedstock to be fed into the apparatus.

The vessel (A-1) for storing liquid feedstock is preferably connected with the means (A-3) for mixing and preheating the liquid feedstock by means of a feeding line. Preferably the liquid feedstock is fed into the means (A-3) for mixing and preheating the liquid feedstock by means of a metered conveying unit such as a pump.

The vessel (A-2) for storing other components can comprise means for calibrating the amount of the other components to be fed into the apparatus. The other components are usually selected from components, which comprise a reactive hydrogen containing species such as hydrogen or hydrogen precursors, or non-reactive species such as nitrogen.

The vessel (A-2) for storing other components is preferably connected with the feeding line for conveying the liquid feedstock by means of at least one additional feeding line. Said additional feeding line can be connected with the feeding line for conveying the liquid feedstock at different positions of the apparatus depending on the process which shall be simulated. One possible position is upstream of the means (A-3) for mixing and preheating the liquid feedstock. Another suitable position is between the means (A-3) for mixing and preheating the liquid feedstock and the isothermal treatment unit (B-1). Still another suitable position is in counterflow mode to the liquid feedstock stream at the other end of the isothermal treatment unit (B-1).

The additional feeding line for conveying the other components preferably comprises a flow controlling unit (A-4) such as a flow valve for metering the flow of the other components into the feeding line for conveying the liquid feedstock. For simulating certain processes no additional components are introduced into the feeding line for conveying the liquid feedstock. For these modes the additional feeding line for conveying the other components preferably is closed by means of the flow controlling unit (A-4).

The means (A-3) for mixing and preheating the liquid feedstock preferably is a preheating unit such as a tubular preheating unit which is preferably surrounded by means for controlling the temperature in the means (A-3) for mixing and preheating the liquid feedstock, like a heater block, preferably an electric heater block.

The means (A-3) for mixing and preheating the liquid feedstock is preferably connected with the hydrogen sulfide (H₂S) production section (B) by means of a feeding line.

The hydrogen sulfide (H₂S) production section (B) preferably comprises an isothermal hydrogen sulfide (H₂S) production unit (B-1), means for controlling the temperature in the isothermal hydrogen sulfide (H₂S) production unit (B-3), and means for controlling the pressure in the isothermal hydrogen sulfide (H₂S) production unit (D-1).

Preferably the isothermal hydrogen sulfide (H₂S) production unit (B-1) is a reactor unit, preferably a tubular reactor unit.

The isothermal hydrogen sulfide (H₂S) production unit (B-1) preferably is connected with the feed preparation section (A), preferably the means (A-3) for mixing and preheating the liquid feedstock, by means of a feeding line. Said feeding line can be connected with the isothermal hydrogen sulfide (H₂S) production unit (B-1) at different positions of the isothermal hydrogen sulfide (H₂S) production unit (B-1) depending on the process which shall be used for producing hydrogen sulfide (H₂S). One suitable position can be the upper part of the isothermal hydrogen sulfide (H₂S) production unit (B-1) as to obtain a downflow of the liquid feedstock in the isothermal hydrogen sulfide (H₂S) production unit (B-1). Another suitable position can be the lower part of the isothermal hydrogen sulfide (H₂S) production unit (B-1) as to obtain an upflow of the liquid feedstock in the isothermal hydrogen sulfide (H₂S) production unit (B-1).

Preferably, the isothermal hydrogen sulfide (H₂S) production unit (B-1) is filled with a packing (B-2) for evenly distributing the pre-treated liquid feedstock along the isothermal hydrogen sulfide (H₂S) production unit (B-1). Said packing (B-2) can either be a non-reactive packing for a non-reactive heat desulfurization of the liquid feedstock in the isothermal hydrogen sulfide (H₂S) production unit (B-1) or a reactive packing for a reactive heat desulfurization of the liquid feedstock in the isothermal hydrogen sulfide (H₂S) production unit (B-1). The reactive packing preferably comprises a catalyst suitable for catalysing the accordant reactive hydro desulfurization of the liquid feedstock and for catalysing the hydrogen sulfide (H₂S) production. Suitable catalysts are based on molybdenum disulphide and/or ruthenium disulphide, which can be modified with smaller amounts of other metals such as cobalt, nickel or tungsten. These catalysts are known from the hydrodesulfurization (HDS) processes of natural gas or refined petroleum products. The packing (B-2) preferably is composed of an appropriate material for the hydrogen sulfide (H₂S) production. It is preferred that either the packing (B-2) in the isothermal hydrogen sulfide (H₂S) production unit (B-1) is exchangeable or that the isothermal hydrogen sulfide (H₂S) production unit (B-1) including a non-exchangeable packing is exchangeable in the apparatus of the invention so that the packing can be adjusted and exchanged for each process for producing hydrogen sulfide (H₂S).

The temperature of the isothermal hydrogen sulfide (H₂S) production unit (B-1) is preferably controlled by means of means for controlling the temperature in the isothermal treatment unit (B-3). Said means for controlling the temperature in the isothermal hydrogen sulfide (H₂S) production unit (B-3) are preferably surrounding the isothermal hydrogen sulfide (H₂S) production unit (B-3), such as a heater block, preferably an electric heater block, surrounding the tubular reactor unit.

The pressure of the isothermal hydrogen sulfide (H₂S) production unit (B-1) is preferably controlled by means for controlling the pressure in the isothermal hydrogen sulfide (H₂S) production unit (D-1). Said means for controlling the pressure in the isothermal hydrogen sulfide (H₂S) production unit (D-1) are not necessarily situated in the hydrogen sulfide (H₂S) production section (B). Suitably the means for controlling the pressure in the isothermal hydrogen sulfide (H₂S) production unit (D-1) is also used for controlling the pressure in the separating section (C). In this embodiment the means for controlling the pressure in the isothermal hydrogen sulfide (H₂S) production unit (D-1) can also be situated downstream of the separating section (C) such as in the product analysis section (D). Suitably the means for controlling the pressure in the isothermal hydrogen sulfide (H₂S) production unit (D-1) is a valve.

The isothermal hydrogen sulfide (H₂S) production unit (B-1) preferably is connected with the separating section (C) by means of a feeding line. The feeding line for connecting the isothermal hydrogen sulfide (H₂S) production unit (B-1) and the separating section (C) is preferably situated on the other end of the isothermal hydrogen sulfide (H₂S) production unit (B-1) with respect to the feeding line for connecting the isothermal hydrogen sulfide (H₂S) production unit (B-1) and the feed preparation section (A).

The separation section (C) preferably comprises at least one separating unit (C-1).

The separating unit (C-1) is preferably is connected with the hydrogen sulfide (H₂S) production unit (B-1) by means of a feeding line.

The separating unit (C-1) is preferably a separating unit suitable to separate a vaporous portion of the liquid feedstock comprising hydrogen sulfide (H₂S) for a liquid portion of the liquid feedstock. Thus, the separating unit (C-1) preferably is a vapour/liquid separator.

The separating unit (C-1) is preferably connected with a storing unit (C-2) for storing liquid portion of the liquid feedstock by means of a feeding line.

Further, the separating unit (C-1) is preferably connected with a second separating unit (C-3) by means of a feeding line.

The second separating unit (C-3) is preferably suitable for separating a vaporous portion comprising hydrogen sulfide (H₂S) from a liquid portion from the vaporous portion of the liquid feedstock which has been separated in the separating unit (C-1). Preferably, the second separating unit (C-3) is a knockout pot.

Preferably the second separating unit (C-3) is connected with the storing unit (C-2) for storing the liquid portions of the liquid feedstock by means of a feeding line for conveying the liquid portion from the second separating unit to the storing unit (C-2).

Further, the second separating unit (C-3) is preferably connected with the product analysis section (D) by means of a feeding line for conveying the vaporous portion comprising hydrogen sulfide (H₂S) from the second separating unit (C-3) to the product analysis section (D).

It is preferred that the means for controlling the pressure in the isothermal hydrogen sulfide (H₂S) production unit (D-1) is situated in the feeding line for conveying the vaporous portion comprising hydrogen sulfide (H₂S) from the second separating unit (C-3) to the product analysis section (D) downstream the second separating unit (C-3).

In the product analysis section (D) the amount of hydrogen sulfide (H₂S) in the vaporous portion of the liquid feedstock is analysed. Optionally, the amount of sulfur containing species in the liquid portion of the liquid feedstock is analysed.

For analysing the amount of hydrogen sulfide (H₂S) in the vaporous portion of the liquid feedstock the product analysis section (D) preferably comprises at least one means (D-2) for monitoring the gas flow of the vaporous portion of the liquid feedstock, such as a flow meter or a wet gas meter.

It is preferred that the means (D-2) for monitoring the gas flow of the vaporous portion of the liquid feedstock is situated in the feeding line for conveying the vaporous portion from the second separating unit (C-3) to the product analysis section (D), preferably downstream the means for controlling the pressure in the isothermal treatment unit (D-1).

For analysing the amount of hydrogen sulfide (H₂S) in the vaporous portion of the liquid feedstock the product analysis section (D) preferably comprises at least one analysing unit for detecting the amounts of H₂S in the vaporous portion of the liquid feedstock, like a gas chromatograph. The analysing unit is preferably situated downstream of the means (D-2) for monitoring the gas flow of the vaporous portion of the liquid feedstock.

For analysing the amount of sulfur containing species in the liquid portion of the liquid feedstock the product analysis section (D) preferably comprises analysing units for detecting the amounts of total sulfur and of mercaptans sulfur in the treated liquid feedstock.

The apparatus according to the present invention further comprises a direct feeding line (E) from the separation section (C) to a laboratory setup for directly introducing the vaporous portion of the liquid feedstock containing hydrogen sulfide (H₂S) into the laboratory setup.

The direct feeding line (E) preferably comprises at least one means (E-1) for controlling the flow rate of the vaporous portion of the liquid feedstock containing hydrogen sulfide (H₂S) to the laboratory setup, such as e.g. a valve.

Further, the direct feeding line (E) preferably comprises at least one means (E-2) for monitoring the gas flow of the vaporous portion of the liquid feedstock, such as a flow meter or a wet gas meter. The means (E-2) for monitoring the gas flow of the vaporous portion of the liquid feedstock is preferably situated in the direct feeding line (E) downstream of the one means (E-1) for controlling the flow rate of the vaporous portion of the liquid feedstock containing hydrogen sulfide (H₂S) to the laboratory setup and upstream of the laboratory setup.

Process

Further, the present invention relates to a process for in-situ producing hydrogen sulfide (H₂S) for laboratory use comprising the following steps:
a) providing a liquid feedstock, which comprises organic sulfur containing components;
b) pre-treating the liquid feedstock;
c) producing hydrogen sulfide (H₂S) from the organic sulfur containing components in the pre-treated liquid feedstock at an elevated temperature;
d) separating a vaporous portion of the liquid feedstock containing the hydrogen sulfide (H₂S) from a liquid portion of the liquid feedstock at a temperature lower than the elevated temperature of hydrogen sulfide (H₂S) production step c);
e) analyzing the amount of hydrogen sulfide (H₂S) in the vaporous portion of the liquid feedstock; and
f) directly feeding the vaporous portion of the liquid feedstock containing the hydrogen sulfide (H₂S) into a laboratory setup.

Preferably, a predetermined flow rate of liquid feedstock is used in the process of the present invention.

The liquid feedstock is preferably preheated to a predetermined temperature in the pre-treatment step b).

In the pre-treatment step b) the liquid feedstock can be mixed with at least one component, which comprises a reactive hydrogen containing species, such as hydrogen or a hydrogen precursor, or a non-reactive species, such as nitrogen.

The liquid feedstock can be mixed with the other component(s) either before or after pre-heating the liquid feedstock.

The pre-treated, preferably preheated, liquid feedstock is then reacted at elevated temperature to produce hydrogen sulfide (H₂S) from the organic sulfur containing components in the pre-treated liquid feedstock.

The treatment step can either be a non-reactive hydrogen sulfide (H₂S) production step at elevated temperature or a reactive hydrogen sulfide (H₂S) production step at elevated temperature.

A reactive treatment step is preferably carried out in the presence of a catalyst.

The non-reactive hydrogen sulfide (H₂S) production step is preferably carried out by treating the organic sulfur containing components in the pre-treated liquid feedstock at elevated temperature and elevated pressure, optionally in the presence of a non-reactive component such as e.g. nitrogen gas.

A suitable reaction temperature for the non-reactive hydrogen sulfide (H₂S) production step is preferably in the range of from 40° C. to 500° C., more preferably in the range of from 100° C. to 450° C. and most preferably in the range of from 250° C. to 425° C.

A suitable reaction pressure for the non-reactive hydrogen sulfide (H₂S) production step is preferably in the range of from 0.3 barg to 5.0 barg, more preferably in the range of from 0.4 barg to 4.5 barg and most preferably in the range of from 1.5 barg to 4.0 barg.

The flow rate ratio of non reactive component to the pre-treated liquid feedstock in the non-reactive hydrogen sulfide (H₂S) production step is preferably in the range of from 60 to 300, more preferably from 70 to 280 and most preferably from 90 to 250.

The reactive hydrogen sulfide (H₂S) production step is preferably carried out by reacting a reactive hydrogen containing species, such as hydrogen or a hydrogen precursor, with the organic sulfur containing components in the pre-treated liquid feedstock at elevated temperature and elevated pressure in the presence of a catalyst suitable for catalyzing the production of hydrogen sulfide (H₂S).

A suitable reaction temperature for the reactive hydrogen sulfide (H₂S) production step is preferably in the range of from 40° C. to 500° C., more preferably in the range of from 100° C. to 450° C. and most preferably in the range of from 150° C. to 425° C.

A suitable reaction pressure for the reactive hydrogen sulfide (H₂S) production step is preferably in the range of from 0.3 barg to 120 barg, more preferably in the range of from 10 barg to 70 barg and most preferably in the range of from 20 barg to 60 barg.

The flow rate ratio of the reactive hydrogen containing species to the pre-treated liquid feedstock in the reactive hydrogen sulfide (H₂S) production step is preferably in the range of from 4 to 1500, more preferably from 20 to 1200 and most preferably from 40 to 400.

Suitable catalysts for the reactive hydrogen sulfide (H₂S) production step are based on molybdenum disulphide and/or ruthenium disulphide, which can be modified with smaller amounts of other metals such as cobalt, nickel or tungsten. These catalysts are known from the hydrodesulfurization (HDS) processes of natural gas or refined petroleum products.

After separating a vaporous portion of the liquid feedstock containing the hydrogen sulfide (H₂S) from a liquid portion of the liquid feedstock at a temperature lower than the elevated temperature of production step c) the liquid portion of the liquid feedstock is preferably stored.

The vaporous portion of the liquid feedstock containing the hydrogen sulfide (H₂S) is preferably again subjected to a separation step in which again a vaporous portion containing the hydrogen sulfide (H₂S) is separated from a liquid portion of the vaporous portion of the liquid feedstock. Said liquid portion is preferably combined with the liquid portion of the liquid feedstock.

The liquid portion of the liquid feedstock is preferably analysed in regard of the amounts of total sulphur and of various types of sulfur compounds such as mercaptans, sulphides, disulfides, thiophenes, benzothiophenes, dibenzothiophenes etc. in the liquid portion of the treated liquid feedstock.

The vaporous portion of the liquid feedstock containing the hydrogen sulfide (H₂S), preferably after the optional second separation step, is preferably analysed in regard of the total amount of gas feed.

Further, the vaporous portion of the liquid feedstock containing the hydrogen sulfide (H₂S), preferably after the optional second separation step, is preferably analysed in regard of the amount of hydrogen sulfide (H₂S), e.g. by gas chromatography.

The vaporous portion of the liquid feedstock containing the hydrogen sulfide (H₂S), preferably after the optional second separation step, is finally directly fed into a laboratory setup.

The process according to the present invention preferably further comprises the step of
g) controlling the flow of the vaporous portion of the liquid feedstock containing the hydrogen sulfide (H₂S) into a laboratory setup, e.g. by means of a valve.

By controlling the flow of the vaporous portion of the liquid feedstock containing the hydrogen sulfide (H₂S) into a laboratory setup, it is possible to introduce the exact amount of hydrogen sulfide (H₂S) into the laboratory set up necessary for the accordant application.

In order to determine the amount of hydrogen sulfide (H₂S) which is produced in the process of the present invention for a specific liquid feedstock under specific production conditions such as temperature, pressure and/or feed rates it is possible to calibrate the process before directly feeding the vaporous portion of the liquid feedstock containing the hydrogen sulfide (H₂S) into a laboratory setup.

The process is preferably calibrated by varying at least one process condition selected from temperature, flow rate of the liquid feed stock and optional other components and pressure in different calibration runs. Thereby, the amount of hydrogen sulfide (H₂S) in the vaporous portion of the liquid feedstock is preferably analyzed for each calibration run. The results of the different calibration runs can be documented e.g. as data banks for a specific liquid feed stock.

The documented data banks for a specific liquid feedstock can then be used as a template for setting the production conditions such as temperature, pressure or feed rate of the specific liquid feed stock and optional other components as to obtain the exact amount of hydrogen sulfide (H₂S) into the laboratory set up necessary for the accordant application.

The results of the analyzing step e) can then be used as quality control.

The liquid feedstock, which comprises organic sulfur containing components, used in the apparatus and the process according to the invention as described above or below is preferably selected from hydrocarbon feedstocks comprising organic sulfur containing components, such as whole crude oil or whole condensate feedstock or from different fractions of distilled crude oil or condensate, such as naphtha, jet fuel, light gas oil, heavy gas oil or fuel oil.

The apparatus and process of the present invention as described above and below are especially suitable for in-situ producing hydrogen sulfide (H₂S) for laboratory use.

Additionally, the apparatus and process of the present invention as described above and below are especially suitable for creating data banks of the production of hydrogen sulfide (H₂S) from various specific liquid feedstock species under different production conditions.

The apparatus and process according to the present invention are further described in more detail below in the description of the figures.

### DESCRIPTION OF THE FIGURES

### Reference Signs

A feed preparation section
A-1 feed tank for liquid feedstock
A-2 surge tank for hydrogen containing gas
A-3 preheater
A-4 flow controller
B hydrogen sulfide (H₂S) production unit
B-1 reactor
B-2 packing
B-3 heater block
C separating unit
C-1 separator
C-2 collection tank
C-3 knock-out drum
D product analysis section
D-1 back pressure regulator
D-2 flowmeter
E direct feeding line
E-1 valve
E-2 flowmeter

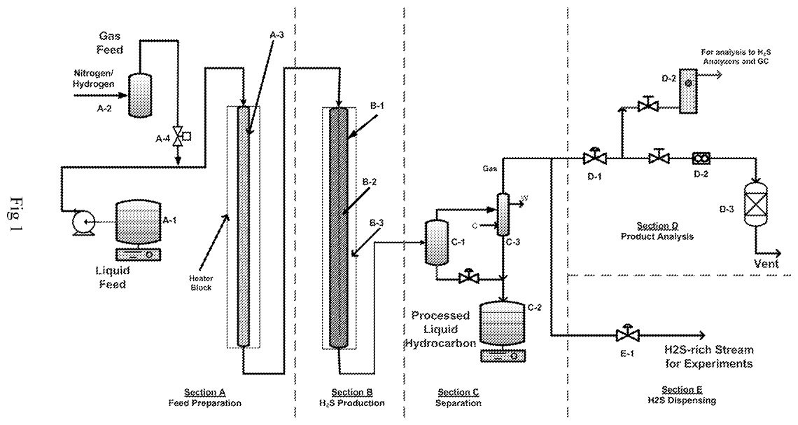

FIG. 1

FIG. 1 shows a diagrammic view of an apparatus for in situ producing hydrogen sulfide (H₂S) for laboratory use according to the invention.

Feed Preparation Section (A):

The liquid feedstock is weighed using a highly accurate balance. It is preheated to a set temperature as per requirement before mixing with a feed gas (diluent gas, e.g. nitrogen, in the case of non-reactive heat treatment, or a reactive gas, e.g. hydrogen, in the case of reactive heat treatment) in the preheating zone (A-3). The feed gas, on the other hand, is metered using a calibrated mass flow controller (A-4) and also preheated to the set temperature.

H₂S Production Section (B):

The feed is introduced to the isothermal feed treatment tube (B-1). The gas could be introduced co-currently or counter-currently in to the feed treatment tube. The liquid hydrocarbon feed can be introduced either in upflow mode or downflow mode, depending on hydrodynamic considerations to maintain stable operations and intimate contact between the gas and liquid phases. The feed treatment tube is further filled with packings (B-2) of appropriate material (non-reactive packing for a non-reactive heat treatment or a hydrotreating catalyst for the case of a reactive heat treatment). The packing will also ensure that the flow is evenly distributed along the feed treatment zone.

The feed treatment tube (B-1) temperature is maintained at the desired level with high accuracy using precisely controlled electric heater blocks (B-3). Process fluid temperature inside the heated tube is monitored by three thermocouples located at different locations of the heated zone (not shown). Pressure is controlled via a back pressure regulator (D-1) located downstream of the knock-out drum (C-3) in the separation section.

Separation section (C):

The H₂S generation tube (B-1) effluent is sent immediately to the separator (C-1), whose temperature is maintained at a set low temperature. The liquid portion is collected in the product vessel (C-2) to be weighed while the gas is sent to a knock-out drum (C-3) (also maintained at a pre-set low temperature, in case any liquid might have been carried over).

Product Analysis Section (D):

The liquid product is analyzed in the laboratory for total sulfur and mercaptans sulfur at the end of each experiment. The setup is also configured adequately for the analysis of the gas product. A pressure control valve (D-1) in the off-gas line controls the system pressure, while the gas volumetric flow rate is metered using a wet gas meter (D-2). The concentration of H₂S leaving the H₂S production section (B) is precisely calculated using material balance.

H₂S Dispensing Section (E):

The produced H₂S-rich vaporous portion of the liquid feedstock will be dispensed to a laboratory setup requiring H₂S-rich stream for any desired experiments. The required flow for this H₂S-rich stream will be controlled by a controlling device E-1, such as e.g. a valve.

Unit Calibration for H₂S Generation

Experimental Conditions for System Calibration:

Variations of (a) temperature, (b) flow rate and (c) pressure will be conducted to generate sufficient data for calibrating the system for a specific liquid feedstock.

Unit Application for H₂S Generation

Once the unit is calibrated using the generated data, precisely controlled operation of the unit will generate a gas stream containing the right concentration of 1425 as demanded by the laboratory requirements.

Results

Apparatus Calibration for Generation and Quantification of H₂S in the Process Stream:

The concentration of H₂S in the process stream has been quantified by effective material balance. This has been demonstrated by developing a predictive model for thermal treatment of 2 different condensate feedstock. The unit can thus be used for generating on-demand stream of H₂S-containing stream.

The same workflow as described above will be used for catalytic processing of a hydrocarbon stream by generating H₂S by desulfurization process.

### CONCLUSIONS

An innovative setup for safe production and supply of H₂S-containing stream for laboratory applications has been developed. This invention will help avoid hazardous storage and utilization of H₂S-containing gas cylinder in laboratory facilities. Further, a precisely controlled on-demand supply of H₂S-containing gas can be provided with easy switch on and off of this gas stream, thereby further minimizing the risk.

1. An apparatus for in situ producing hydrogen sulfide (H₂S) for laboratory use comprising
a feed preparation section (A) for pre-treating the liquid feedstock which comprises organic sulfur containing components;
a hydrogen sulfide (H₂S) production section (B) downstream the feed preparation section (A) for producing hydrogen sulfide (H₂S) from the organic sulfur containing components in the liquid feedstock at elevated temperature;
a separation section (C) downstream the hydrogen sulfide (H₂S) production section (B) for separating a vaporous portion of the liquid feedstock containing hydrogen sulfide (H₂S) from a liquid portion of the liquid feedstock at a temperature lower than the elevated temperature of the hydrogen sulfide (H₂S) production section (B);
a product analysis section (D) downstream the separation section for analyzing the amount of hydrogen sulfide (H₂S) in the vaporous portion of the liquid feedstock;
a plurality of feeding lines for conveying the liquid feedstock from the feed preparation section (A) to the hydrogen sulfide (H₂S) production section (B) to the separation section (C) and to the product analysis section (D); and
a direct feeding line (E) from the separation section (C) to a laboratory setup for directly introducing the vaporous portion of the liquid feedstock containing hydrogen sulfide (H₂S) into the laboratory setup.

2. The apparatus according to claim 1 further comprising means (E-1) for controlling the flow rate of the vaporous portion of the liquid feedstock in the direct feeding line (E).

3. The apparatus according to claim 1, wherein the feed preparation section (A) comprises a vessel (A-1) for storing liquid feedstock, a vessel (A-2) for storing further components, means (A-3) for mixing and preheating the liquid feedstock and the further components and means (A-4) for controlling the flow rate of the further components.

4. The apparatus according to claim 1, wherein the hydrogen sulfide (H₂S) production section (B) comprises an isothermal hydrogen sulfide (H₂S) production unit (B-1), means for controlling the temperature in the hydrogen sulfide (H₂S) production unit (B-3), and means for controlling the pressure in the isothermal hydrogen sulfide (H₂S) production unit (D-1).

5. The apparatus according to claim 4, wherein the isothermal hydrogen sulfide (H₂S) production unit (B-1) is filled with a packing (B-2) for evenly distributing the pre-treated liquid feedstock along the isothermal hydrogen sulfide (H₂S) production unit (B-1).

6. The apparatus according to claim 5, wherein the packing (B-2) includes a catalyst for catalytically producing hydrogen sulfide (H₂S).

7. The apparatus according to claim 1, wherein the separation section (C) includes at least one separating unit (C-1).

8. A process for in-situ producing hydrogen sulfide (H₂S) for laboratory use comprising the following steps:
a) providing a liquid feedstock, which comprises organic sulfur containing components;
b) pre-treating the liquid feedstock;
c) producing hydrogen sulfide (H₂S) from the organic sulfur containing components in the pre-treated liquid feedstock at an elevated temperature;
d) separating a vaporous portion of the liquid feedstock containing the hydrogen sulfide (H₂S) from a liquid portion of the liquid feedstock at a temperature lower than the elevated temperature of hydrogen sulfide (H₂S) production step c);
e) analyzing the amount of hydrogen sulfide (H₂S) in the vaporous portion of the liquid feedstock; and
f) directly feeding the vaporous portion of the liquid feedstock containing the hydrogen sulfide (H₂S) into a laboratory setup.

9. The process according to claim 8, further comprising the set of
g) controlling the flow of the vaporous portion of the liquid feedstock containing the hydrogen sulfide (H₂S) into a laboratory setup.

10. The process according to claim 8, wherein in the pre-treatment step the liquid feedstock is mixed with at least one component, which comprises a reactive hydrogen containing species.

11. The process according to claim 8, wherein hydrogen sulfide (H₂S) is produced from the organic sulfur containing components in the pre-treated liquid feedstock in the presence of a catalyst.

12. The process according to claim 8, wherein process is calibrated for a specific liquid feedstock species before directly feeding the vaporous portion of the liquid feedstock containing the hydrogen sulfide (H₂S) into a laboratory setup.

13. The process according to claim 13 wherein the process is calibrated by varying at least one process condition selected from temperature, flow rate and pressure and in different calibration runs and the amount of hydrogen sulfide (H₂S) in the vaporous portion of the liquid feedstock is analyzed for each calibration run.

14. The process according to claim 8, wherein the liquid feedstock is selected from different fractions of distilled crude oil.

15. (canceled)

16. (canceled)
